(19) United States
(12) Patent Application Publication
(10) Pub. No.: US 2011/0112834 A1
(43) Pub. Date: May 12, 2011

(54) Communication method and terminal

(75) Inventor: Hee Jun You, Seoul (KR)

(73) Assignee: SAMSUNG ELECTRONICS CO., LTD., Suwon-si (KR)

(21) Appl. No.: 12/925,712

(22) Filed: Oct. 28, 2010

(30) Foreign Application Priority Data
Nov. 10, 2009 (KR) 10-2009-0107927

(51) Int. Cl. G10L 15/26; G10L 13/00

(52) U.S. Cl. 704/235; 704/260; 704/E15.043; 704/E13.011

(57) ABSTRACT

A communication method and terminal assist hearing and speech impaired persons. The communication method includes generating a text by combining at least one character input in a text call mode. The text is converted to a speech, and the converted speech is transmitted to a counterparty terminal. The communication terminal of the present invention is capable of converting the text input by the user to a speech signal for the counterparty terminal and converting the speech signal received from the counterparty terminal to a text such that it is possible for the user to conduct a communication with the counterparty regardless of whether the counterparty is a hearing or speech impaired or whether the counterparty's terminal supports the text call service, resulting in reduction of the text call service implementation complexity and improvement of user convenience.

### CROSS-REFERENCE TO RELATED APPLICATION(S) AND CLAIM OF PRIORITY

The present application is related to and claims priority to an application entitled “COMMUNICATION METHOD AND TERMINAL” filed in the Korean Intellectual Property Office on Nov. 10, 2009 and assigned Serial No. 10-2009-0107927, the contents of which are incorporated herein by reference.

### TECHNICAL FIELD OF THE INVENTION

The present invention relates to wireless communications and, in particular, to a communication method and terminal for assisting hearing and speech impaired persons.

### BACKGROUND OF THE INVENTION

Communication systems provide communication terminals with various communication services. The communication services include voice communication service, text messaging service, Internet access service, financial transaction service, and such. The communication terminals are equipped with various functions for supporting these services. Some communication terminals are implemented to support a text call service in which a hearing or speech impaired person conducts a conversation with a hearing person. That is, the text call service allows the owner of the text call service-enabled terminal to conduct a voice or a text conversation with a counterparty person.

When using the communication terminal supporting the text call service, the calling party must conduct a text call conversation with the called party regardless of whether the called party is hearing/speech impaired. Accordingly, a text call assistant device is needed by the called party's terminal as well as the calling party's terminal. As shown in FIG. 1, the communication terminal 110 is connected to a text call assistant device 120 for facilitating text input/output, and the communication terminal 130 is also connected to another text call assistant device 140. However, the conventional text call service has a drawback in that the system implementation is complex so as to degrade user convenience.

### SUMMARY OF THE INVENTION

To address the above-discussed deficiencies of the prior art, it is a primary object to provide a communication method and terminal that is capable of reducing implementation complexity of text call service and improving user convenience.

In accordance with an aspect of the present invention, a communication method of a communication terminal includes generating a text by combining at least one character input in a text call mode. The text is converted to a speech, and the converted speech is transmitted to a counterparty terminal.

In accordance with another aspect of the present invention, a communication terminal includes a text generator which combines at least one character input in a text call mode into a text. A text-speech converter converts the text to a speech, and a transmitter transmits the converted speech to a counterparty terminal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a conventional communication system for supporting text call service according to the present disclosure;

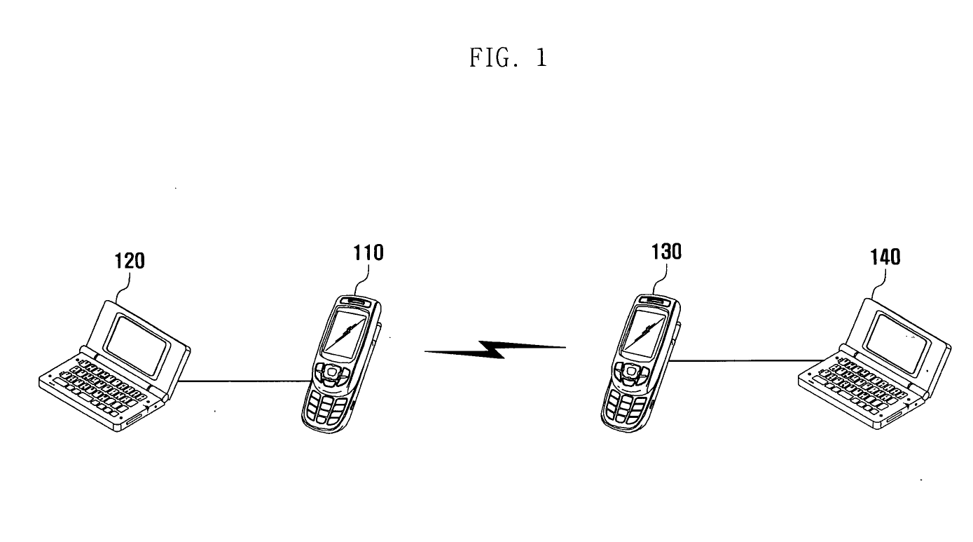

FIG. 2 illustrates a communication system for supporting text call service according to an embodiment of the present invention;

FIG. 3 illustrates a configuration of a communication terminal according to an embodiment of the present invention;

FIG. 4 illustrates a configuration of the text-speech processor of FIG. 3 according to an embodiment of the present invention;

FIG. 5 illustrates the speech-text processor of FIG. 3 according to an embodiment of the present invention; and

FIG. 6 illustrates a text call process for a communication terminal according to an embodiment of the present invention.

### DETAILED DESCRIPTION OF THE INVENTION

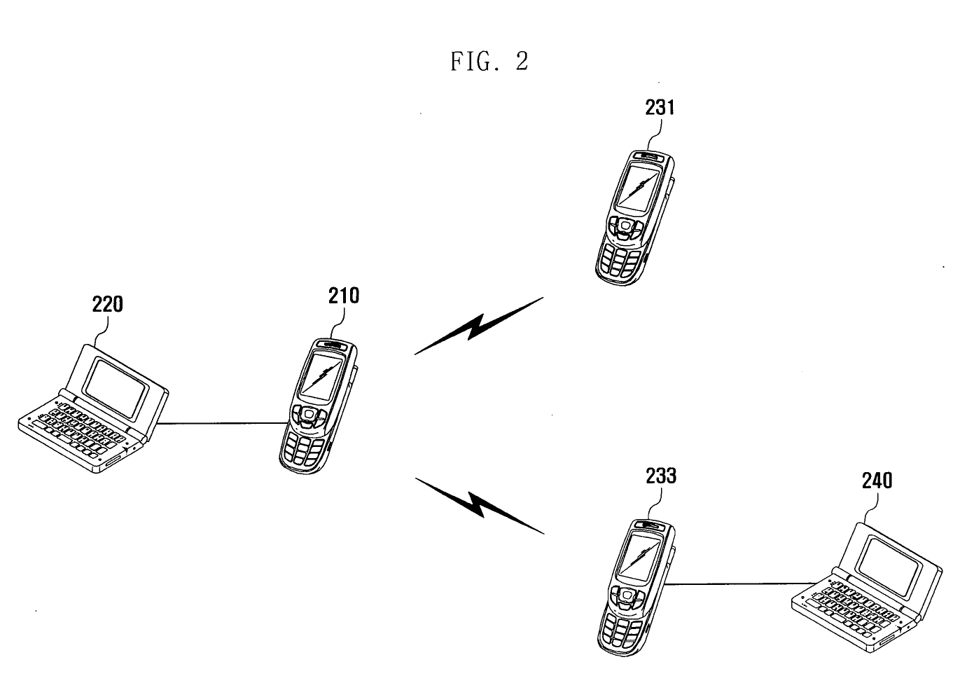

FIGS. 2 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication terminal. Embodiments of the present invention are described with reference to the accompanying drawings in detail. The same reference numbers are used throughout the drawings to refer to the same or like parts. Detailed description of well-known functions and structures incorporated herein may be omitted to avoid obscuring the subject matter of the present invention.

FIG. 2 illustrates a communication system according to an embodiment of the present invention.

The communication system according to an embodiment of the present invention provides the communication terminals 210, 231, and 233 with communication services. The communication terminals 210, 231, and 233 conduct communication with each other by means of the services provided by the communication system. In FIG. 2, the communication terminal 210 is equipped with a text call function for a hearing/speech impaired person to conduct communication with another text call-enabled terminal (e.g. communication terminal 233) or a normal communication terminal (e.g. communication terminal 231). That is, the communication terminal 210 is a text call-enabled terminal and can conduct a communication with a normal communication terminal 231 or another text call-enabled terminal 233. In order for the communication terminal 210 to make a text call, it should be connected to a text call assistant device 220. However, the counterparty terminals 231 and 233 can be connected to a text call assistant device 240 or not. Here, the text call assistant devices 220 and 240 can be teletypewriters (TTYs).

When a text is input by means of the text call assistant device 220, the communication terminal 210 converts the text to a speech signal and sends the speech signal to the counterparty terminal 231 (or 233). Also, when a speech signal is received from the counterparty terminal 231 (or 233), the communication terminal 210 converts the speech signal to a text and displays the text on the screen of the text call assistant device 220. Accordingly, the communication terminal 210 allows its owner to communication with the counterparty that has the communication terminal 231 supporting text call function or the communication terminal 233 that includes the text call function.

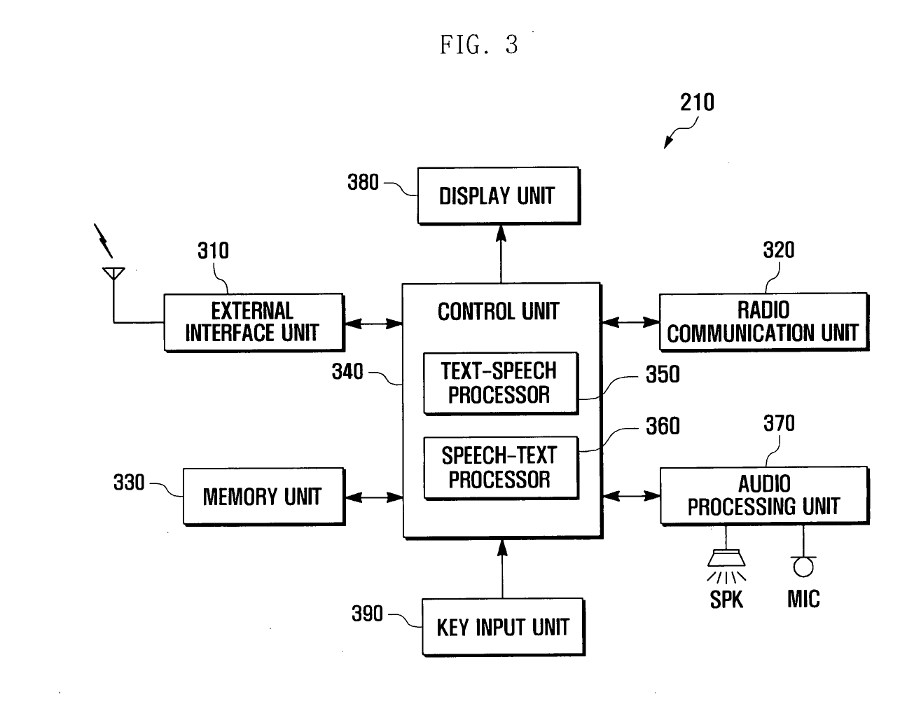

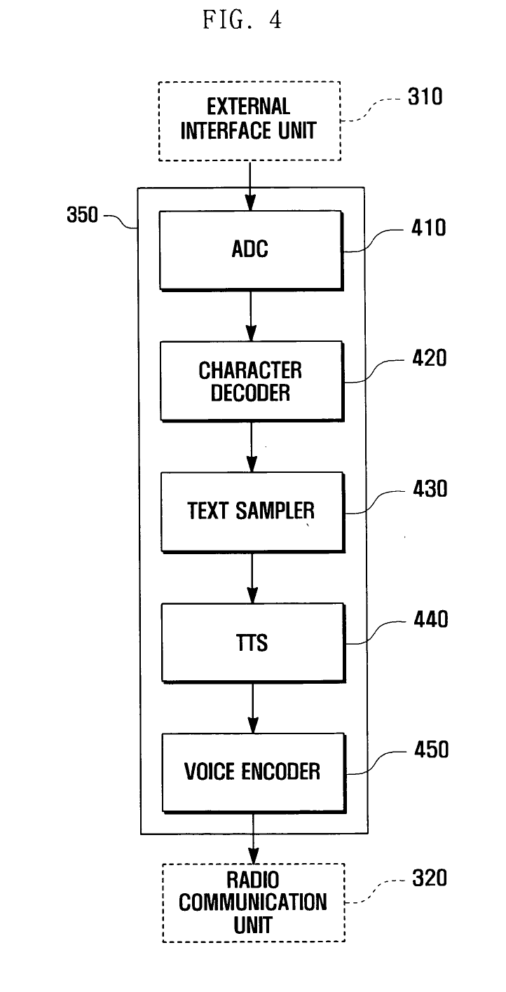

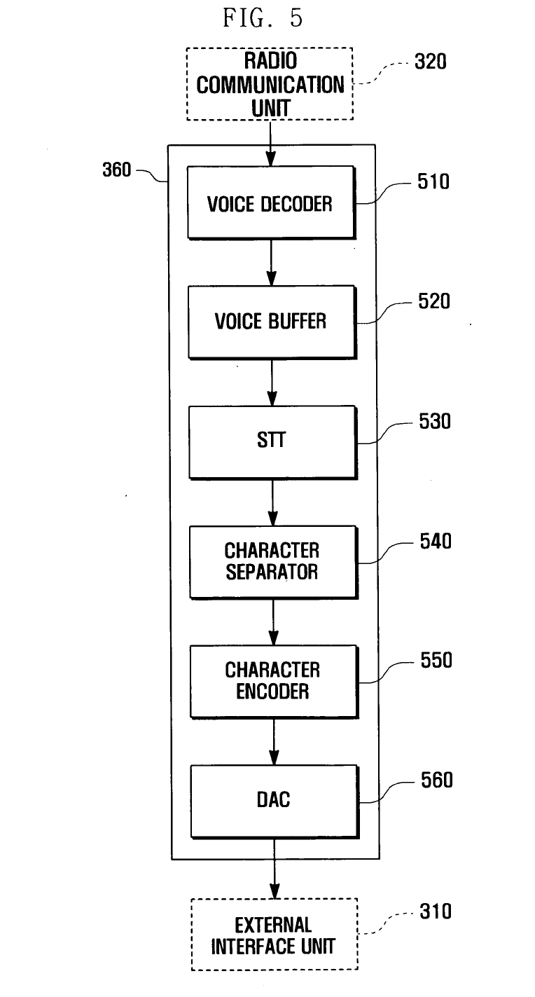

FIG. 3 illustrates a configuration of a communication terminal according to an embodiment of the present invention. FIG. 4 illustrates a configuration of the text-speech processor of FIG. 3 according to an embodiment of the present invention. And FIG. 5 illustrates the speech-text processor of FIG. 3 according to an embodiment of the present invention.

As shown in FIG. 3, the communication terminal 210 includes an external interface unit 310, a radio communication unit 320, a memory unit 330, a control unit 340, an audio processing unit 370, a display unit 380, and a key input unit 390.

The external interface unit 310 is responsible for establishing connection with an external device. The external interface unit 310 provides an interface for connecting the mobile terminal to a peripheral device such as text call assistant device 220. The external interface unit 310 can be implemented to establish a wired or a wireless connection with a peripheral device.

The radio communication unit 320 is responsible for radio communication of the communication terminal 210. The radio communication unit 320 includes a transmitter for up-converting and amplifying transmission signals and a receiver for low noise amplifying and down-converting received signals.

The memory unit 330 can be divided into a program memory and a data memory. The program memory stores application programs related to the operations of the communication terminal 210. Particularly in an embodiment of the present invention, the program memory stores the application programs implementing the text call function. The data memory stores the data generated while the application programs are running.

The control unit 340 controls entire operations of the mobile terminal 210. The control unit 340 includes a data processing unit that includes a transmission processor for encoding and modulating the transmission signals and a reception processor for demodulating and decoding the received signals. The data processing unit can include a modem and a codec. The codec is provided with a data codec for processing packet data and a voice codec for processing voice signal. Particularly in an embodiment of the present invention, the control unit 340 controls to perform the text call function in text call mode. That is, when the communication terminal 210 operates in text call mode, the control unit 340 can convert a text input through the external interface unit 310 to a speech signal and transmit the speech signal to the counterparty terminal through the radio communication unit 320. The control unit 340 can also convert the voice signal received through the radio communication unit 320 to a text and output the text to the text call assistant device 220 through the external interface unit 310. For these purposes, the control unit 340 includes a text-speech processor 350 and a speech-text processor 360.

The text-speech processor 350 is provided for assisting speech-impaired persons. As shown in FIG. 4, the text-speech processor 350 includes an Analog to Digital Converter (ADC) 410, a character decoder 420, a text sampler 430, a Text To Speech (TTS) converter 440, and a voice encoder 450. If an analog signal representing Baudot code is received from the text call assistant device 220 through the external interface unit 310, the ADC 410 converts the analog signal to a digital signal with Pulse Code Modulation (PCM). The character decoder 420 performs decoding on the digital signal to detect characters. The text sampler 430 combines at least one character to output a text. The TTS 440 converts the text to a speech signal. The voice encoder 450 encodes the speech signal to output a voice packet to the radio communication unit 320.

The speech-text processor 360 is provided for assisting hearing-impaired persons. As shown in FIG. 5, the speech-text processor 360 includes a voice decoder 510, a voice buffer 520, a Speech To Text (STT) converter 530, a character separator 540, a character encoder 550, and a Digital to Analog Converter (DAC) 560. If a voice packet is received by the radio communication unit 320, the voice decoder 510 decodes the voice packet into a speech signal. The voice buffer 520 buffers the speech signal. The STT 530 converts the speech signal into a text composed of at least one character. The character encoder 550 encodes the characters of the text to a digital signal. The DAC 560 converts the digital signal to an analog signal representing a Baudot code and outputs the analog signal to the text call assistant device 220 through the external interface unit 310.

The audio processing unit 370 processes the received voice signal output by the voice codec of the data processing unit so as to output the voice signal through a speaker (SPK) in the form of audible sound wave and processes the audio signal input through a microphone (MIC) so as to output the audio signal to the audio codec of the data processing unit.

The display unit 380 displays visual data output by the control unit 340. The display unit 380 can be implemented with a Liquid Crystal Device (LCD). In an embodiment, the display unit 380 can include an LCD controller, video memory for storing visual data, and LCD devices. When the LCD is enabled with touchscreen technology, the display unit 380 can work as an input device.

The key input unit 390 is provided with a plurality of alphanumeric keys for receiving alphabetic and numeric data and functions keys for configuring various function of the terminal.

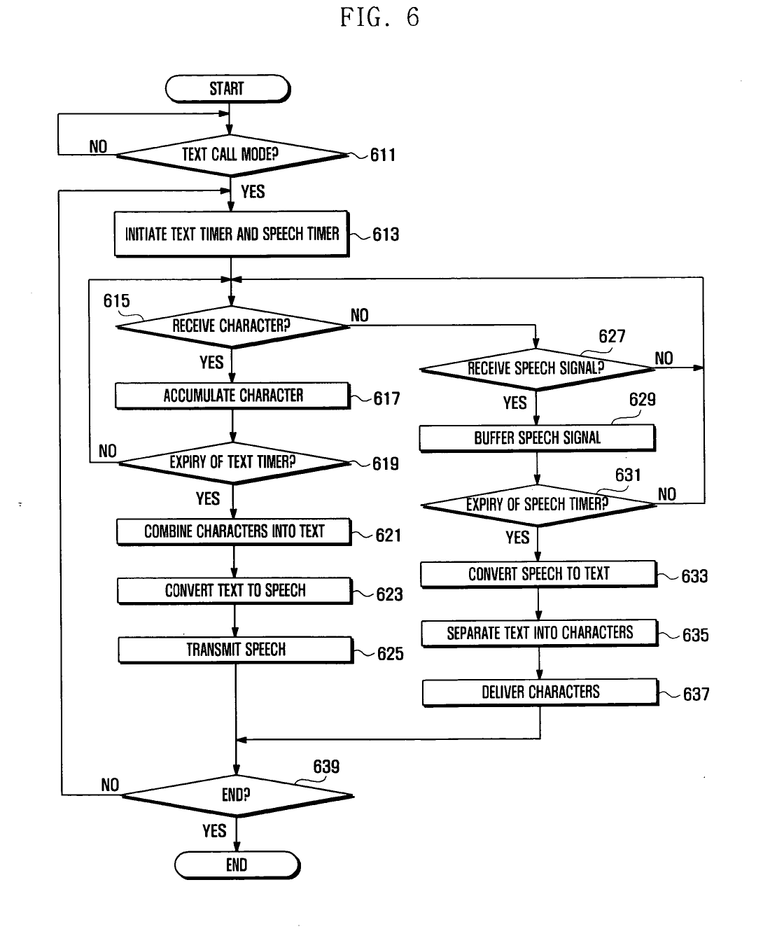

FIG. 6 illustrates a text call process for a communication terminal according to an embodiment of the present invention.

Referring to FIG. 6, the control unit 340 of the communication terminal 210 monitors to detect a request for activation of the text call mode in block 611. For example, if a text call mode activation command is input through the key input unit 390, the control unit 340 activates the text call mode. The control unit 340 can be configured such that, when the text call assistant device 200 is connected to the external interface unit 310, the communication terminal 210 activates the text call mode. In the text call mode, the control unit 340 initiates a text timer and a speech timer in block 613. The text timer and speech timer can be configured so as to be initialized at predetermined interval. After entering the text call mode, the control unit 340 monitors to detect receipt of a character through the external interface unit 310 while the text timer is running in block 615. If a character is received, the control unit 340 accumulates the received character in block 617. After accumulating the character, the control unit 340 determines whether the text timer has expired in block 619. If the text timer has expired, the control unit 340 combines the characters accumulated before the expiry of the text timer to produce a text in block 621. Otherwise, if the text timer has not expired at block 619, the control unit 340 repeats blocks 615 to 619. That is, the control unit 340 can combine at least one character accumulated before the expiry of the text timer to produce a text.

For example, if characters ‘H’, ‘E’, ‘L’, ‘L’, ‘O’, ‘,’, ‘ ’, ‘M’, ‘Y’, ‘ ’, ‘N’, ‘A’, ‘M’ and ‘E’ are received in sequential order after the start of the text timer, the control unit 340 accumulates the characters. If the expiry of the text timer is detected, the control unit 340 combines the accumulated characters with reference to the spaces ‘ ’ and punctuation marks such as ‘,’, ‘.’, ‘!’, and ‘?’ to produce a text. Here, the control unit 340 generates a text with the characters accumulated between delimiter characters. That is, the control unit 340 combines the characters ‘H’, ‘E’, ‘L’, ‘L’, ‘O’, ‘,’, ‘ ’, ‘M’, ‘Y’ and ‘ ’ into ‘HELLO’ and ‘MY’. Here, the control unit 340 maintains the characters ‘N’, ‘A’, ‘M’, and ‘E’ as they accumulated.

Once the text is acquired, the control unit 340 converts the text to a speech signal in block 623. Next, the control unit 340 transmits the speech signal to the counterparty terminal in block 625.

If no character is received in predetermined time at block 615, the control unit 340 determines whether a speech signal is received through the radio communication unit 320 while the speech timer is running in block 627. If a speech signal is received, the control unit 340 detects the receipt of the speech signal and buffers the speech signal in block 629.

The control unit 340 monitors to detect the expiry of the speech timer while buffering the speech signal in block 631. If the expiry of the speech timer is detected, the control unit 340 converts the buffered speech signal to a text in block 633. If no expiry of the speech timer is detected at block 631, the control unit 340 returns the procedure to repeat blocks 627 to 631. That is, the control unit 340 buffers the speech signal received between the start and end of the speech timer and converts the buffered speech signal to a text.

Next, the control unit 340 separates the text into at least one character in block 635 and delivers the separated characters to the text call assistant device 220 through the external interface unit 310 in block 637. For example, the control unit 340 separates the text ‘HELLO’ into individual characters ‘H’, ‘E’, ‘L’, ‘L’, and ‘O’ and transfers these characters to the text call assistant device 220 in sequential order.

Finally, the control unit 340 monitors to detect whether a text call mode termination command is input in block 639. If a text call mode termination command input is detected, the control unit 340 ends the text call mode communication procedure. If no text call mode termination command input is detected at block 639, the control unit 340 returns the procedure to repeat blocks 613 to 639. That is, the control unit 340 initializes the text timer and the speech timer. Next, the control unit 340 converts the characters input through the external interface unit 310 to a speech signal and transmits the speech signal through the radio communication unit 320. When at least one character is accumulated, the control unit 340 can generate the speech signal by accumulating at least one more character input through the external interface unit 310. The control unit 340 also processes the speech signal received through the radio communication unit 320 into a series of characters and delivers the characters to the text call assistant device 220.

Although the description is directed to the text call service provided with the external text call assistant device 220 connected to the communication terminal 210, the present invention is not limited thereto.

That is, the communication terminal 210 can be configured to operate in the text call mode without connection to the text call assistant device 220. This means that the text call service can be implemented with the communication terminal that does not include the external interface unit 310.

For example, when at least one character is input through the key input unit 390 of the communication terminal 210, the control unit 340 can accumulate the at least one character to produce a text. If the communication terminal 210 receives a speech signal by means of the radio communication unit 320, the control unit 340 can convert the speech signal to a text and display the text on the display unit 380.

Although the description is directed to the communication terminal 210 operating in the text call mode for assisting the hearing or speech impaired person in which the communication terminal converts the input text to a speech signal to be transmitted and the received speech signal into a text, the present invention is not limited thereto. That is, the present invention can be implemented with the communication terminal 210 which is configured to transmit the input speech signal and convert the received speech signal to a text to be displayed on the display unit. Also, the present invention can be implemented with the communication terminal 210 which is configured to convert the input text to a speech signal to be transmitted and outputs the received speech signal through a speaker in the form of audible sound wave.

For example, the communication terminal 210 can be configured to operate in one of a full text exchange mode for the hearing and speech impaired person, a Voice Carryout (VCO) mode for the hearing impaired person, and a Hearing Carryout (HCO) mode for the speech impaired person. The communication terminal 210 can perform one of the full text exchange mode, VCO mode, and HCO mode selectively. In the full text exchange mode, the communication terminal 210 converts the input text to a speech signal to be transmitted and converts the received speech signal to a text to be displayed. In the VCO mode, the communication terminal 210 transmits the speech signal input through the microphone and converts the received speech signal to a text. In the HCO mode, the communication terminal 210 converts the input text to a speech signal to be transmitted and outputs the received speech signal through the speaker.

According to the present invention, the communication terminal 210 can exchange speech signals with counterparty terminals 231 and 233 in the text call mode for a hearing or speech impaired person. That is, the communication terminal 210 can perform conversion between text for hearing impaired person and speech signal for the hearing person such that the owner of the terminal 210 can communicate with a counterparty regardless of whether the counterparty is a hearing or hearing-impaired person and whether the counterparty's terminal supports the text call function. Accordingly, the communication method of the present invention is capable of reducing implementation complexity of the text call service for hearing/speech impaired persons and improving user convenience.

As described above, the communication method and terminal of the present invention is capable of converting between text and speech in text call mode for assisting the hearing and speech impaired persons so as to communicate speech signals with the counterparty terminal. Because the communication terminal of the present invention can convert the text input by the user to a speech signal for the counterparty terminal and convert the speech signal received from the counterparty terminal to a text for hearing impaired person, it is possible for the user to conduct a communication with the counterparty regardless of whether the counterparty is a hearing or hearing impaired and whether the counterparty's terminal supports the text call service, resulting in reduction of the text call service implementation complexity and improvement of user convenience.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A communication method of a communication terminal, comprising:
generating an input text for conversion by combining at least one character input in a text call mode;
converting the input text to a transmit speech; and
transmitting the transmit speech to a counterparty terminal.

2. The communication method of claim 1, further comprising:
receiving a speech from the counterparty terminal;
converting the received speech to an output text; and
decoding the output text into at least one character for display.

3. The communication method of claim 1, wherein generating the input text comprises:
initiating a text timer at the start of the text call mode;
accumulating the at least one character; and
combining, when the text timer expires, the at least one character into the input text.

4. The communication method of claim 2, wherein converting the received speech to the received text comprises:
initiating a speech timer at start of the text call mode;
buffering the received speech; and
converting, when the speech timer expires, the received speech to the output text.

5. The communication method of claim 2, further comprising executing the text call mode when the at least one character is input or an external device for entering and displaying text is connected to the communication terminal.

6. A communication terminal comprising:
a text generator configured to combine at least one character input in a text call mode into an input text;
a text-speech converter configured to convert the input text to a transmit speech; and
a transmitter configured to transmit the transmit speech to a counterparty terminal.

7. The communication terminal of claim 6, further comprising:
a receiver configured to receive a speech from the counterparty terminal;
a speech-text converter configured to convert the received speech to an output text; and
a character decoder which decodes the received text into at least one character for display.

8. The communication terminal of claim 6, wherein the text generator is further configured to:
initiate a text timer at start of the text call mode;
accumulate the at least one character input; and
combine, when the text timer expires, the at least one character input into the input text.

9. The communication terminal of claim 7, further comprising a buffer configured to buffer the received speech, wherein the speech-text converter is further configured to:
initiate a speech timer at start of the text call mode, and
convert, when the speech timer expires, the received speech to the output text.

10. The communication terminal of claim 7, further comprising:
an external interface configured to connect the communication terminal to a text call assistant device for inputting and displaying the at least one character; and
a control unit configured to execute the text call mode when the text call assistant device is connected to the communication terminal.
